(19) United States
(12) Patent Application Publication
(10) Pub. No.: US 2025/0171619 A1
(43) Pub. Date: May 29, 2025

(54) Food Contact Polymer Composition With Mold Release Properties

(71) Applicant: Celanese International Corporation, Irving, TX (US)

(72) Inventors: Qamer Zia, Raunheim (DE); Kirsten Markgraf, Weinheim (DE); Dirk Zierer, Hattersheim (DE); Patrick Nickolay, Villmar (DE)

(21) Appl. No.: 18/961,908

(22) Filed: Nov. 27, 2024

Related U.S. Application Data
(60) Provisional application No. 63/603,896, filed on Nov. 29, 2023.

(51) Int. Cl. C08K 7/14; C08K 3/26; C08K 3/34; C08K 5/098; C08L 67/03

(52) U.S. Cl. CPC C08K 7/14; C08K 3/26; C08K 3/346; C08K 5/098; C08L 67/03; C08K 2003/262; C08K 2201/019

(57) ABSTRACT

A fiber reinforced thermoplastic polymer composition is disclosed that contains at least one mold release agent and at least one nucleant. The polymer compositions are formulated to be food grade compliant and display not only excellent mechanical properties but very fast crystallization rates that lead to very fast cycle times.

### RELATED APPLICATION

The present application is based upon and claims priority to U.S. Provisional Patent Application Ser. No. 63/603,896, having a filing date of Nov. 29, 2023, which is incorporated herein by reference.

### BACKGROUND

Engineering thermoplastics and elastomeric materials are often used in numerous and diverse applications in order to produce molded parts and products. For instance, thermoplastic polymers are used to produce all different types of molded products, such as injection molded products, blow molded products, and the like. Thermoplastic polymers, for instance, can be formulated in order to be chemically resistant, to have excellent strength properties and, when formulating compositions containing elastomers, to be flexible. Of particular advantage, many polymers can be melt processed due to their thermoplastic nature. In addition, many polymers can be recycled and reprocessed.

One objective in producing molded parts from thermoplastic polymers is the ability to quickly mold the parts and increase productivity. Each polymer formulation, for instance, can present a unique set of problems related to the melt processing characteristics of the composition which can create longer cycle times, cause mold deposits to form, and/or negatively impact the ability to remove the part from a mold. Consequently, ideally a thermoplastic composition is formulated so as to form a stable melt at the melt processing conditions. In many applications, faster crystallization rates and/or faster melt-solidification rates are desirable in order to shorten cycle times.

In the past, various lubricants and/or mold release agents have been suggested for use with thermoplastic polymers, such as polyester polymers, that facilitate mold release and shorten cycle times by increasing crystallization rates. For instance, one lubricant or mold release agent used in the past is sodium montanate. Although sodium montanate is well suited for use with polyester polymer compositions, sodium montanate and various other conventional lubricants and mold release agents are not food grade acceptable. In particular, these components are not capable of being incorporated into polymer compositions that are used to produce molded articles that are designed to contact foods. More specifically, certain montanate waxes such as polyhydric alcohol esters of oxidatively refined monatan wax acids and various other components currently do not meet governmental regulations regarding food contact.

Thus, when formulating a polymer composition that is used to produce food contact articles, further obstacles and problems are encountered in choosing components that have food grade approval.

The present disclosure is directed to a thermoplastic polymer composition, particularly a polyester polymer composition that not only has fast cycle times and fast crystallization rates but also meets all food contact governmental regulations.

### SUMMARY

The present disclosure is generally directed to a thermoplastic polymer composition, particularly a polyester polymer composition, that is formulated to be food grade compliant while still having fast cycle times and a fast crystallization rate. The polymer composition, for instance, excludes many conventional mold release agents while containing a food grade compliant mold release agent in combination with one or more nucleants.

In one embodiment, for instance, the present disclosure is directed to a polymer composition comprising a thermoplastic polymer, such as a polyester polymer. In one aspect, the thermoplastic polymer can be a polyethylene terephthalate polymer. The thermoplastic polymer or polyethylene terephthalate polymer can be present in the polymer composition in an amount greater than about 20% by weight, such as in an amount greater than about 40% by weight, such as in an amount greater than about 50% by weight, such as in an amount greater than about 60% by weight, and in an amount less than about 85% by weight. The thermoplastic polymer is blended with a reinforcing filler which can be present in the polymer composition in an amount from about 5% to about 55% by weight. In one aspect, the reinforcing filler can comprise glass fibers and can be present in the polymer composition in an amount from about 15% by weight to about 40% by weight, such as in an amount from about 25% by weight to about 35% by weight. In accordance with the present disclosure, the polymer composition further contains at least one nucleant and a mold release agent. The mold release agent is a food contact grade component that meets the requirements of FDA Title 21 Part 177 (Indirect Food Additives: Polymers) of the Code of Federal Regulations and/or European (EC) Food Contact Regulation No. 10/2011 for Plastics.

In one aspect, the mold release agent comprises a polyethylene wax, such as an oxidized polyethylene wax. The mold release agent or polyethylene wax can have a density of greater than about 0.96 g/cm³, such as greater than about 0.97 g/cm³, according to ISO Test 1183. The mold release agent or polyethylene wax can also display a drop point of from about 120° C. to about 125° C. when tested according to ISO Test 2176. The mold release agent or polyethylene wax can have a viscosity of greater than about 1700 mPa-s, such as greater than about 1750 mPa-s, such as greater than about 1790 mPa-s, when tested according to DIN Test 53019 at 140° C. In one aspect, the mold release agent or polyethylene wax can also have an acid value of from about 10 KOH/g to about 25 KOH/g.

As described above, the polymer composition also contains at least one nucleant. The nucleant can comprise a sodium ionomer, sodium bicarbonate, sodium benzoate, silica, a phosphate ester, or mixtures thereof. The nucleant can be present in the polymer composition in an amount less than about 2% by weight, such as in an amount less than about 1% by weight, such as in an amount less than about 0.5% by weight, and in an amount greater than about 0.01% by weight, such as in an amount greater than about 0.1% by weight. Similarly, the mold release agent can be present in the polymer composition in an amount less than about 2% by weight, such as in an amount less than about 1% by weight, such as in an amount less than about 0.5% by weight, and in an amount greater than about 0.01% by weight, such as in an amount greater than about 0.1% by weight.

In one aspect, every component contained in the polymer composition complies with the United States Food and Drug Administration standards listed under FDA CFR Title 21 Part 177. In one aspect, the polymer composition does not contain a montanic acid, a salt thereof, or an ester thereof.

The present disclosure is also directed to molded articles made from the polymer composition as described above. The molded article, for instance, can comprise a component or part of food handling equipment. In one particular embodiment, the molded article comprises a component of an air fryer, such as a drip pan. In another embodiment, the molded article comprises a food tray.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a perspective view of one embodiment of a food contact article that may be made in accordance with the present disclosure; and

FIG. 2 is a perspective view of a part or component made from the polymer composition of the present disclosure that can be incorporated into food handling equipment.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only and is not intended as limiting the broader aspects of the present disclosure.

In general, the present disclosure is directed to a thermoplastic polymer composition that is formulated for food contact applications. For example, in one aspect, every component of the polymer composition can be food grade compliant and meet all of the governmental regulations regarding food handling. In this regard, the polymer composition is also formulated so as to not contain various conventional components and ingredients that are not food grade compliant.

In the past, many food grade component parts and products were formed from polypropylene polymers. Polypropylene polymers, however, have various drawbacks and deficiencies. For instance, polypropylene polymers display relatively poor impact strength and have a tendency to display stress whitening and failures during handling. Polypropylene polymers are also susceptible to staining, especially when contacting various different food types. In addition to problems associated with staining, polypropylene polymers also experience odor retention problems.

The polymer composition of the present disclosure, however, can be formulated to contain a polyester polymer, such as a polyethylene terephthalate polymer. In accordance with the present disclosure, the polyester polymer is blended with a reinforcing agent such as glass fibers, at least one food grade compliant nucleant, and at least one food grade compliant mold release agent. The resulting polymer composition displays very fast crystallization rates leading to very fast cycle times when molding. In addition, the polymer composition displays excellent mechanical properties that overcome many of the disadvantages and drawbacks related to polypropylene compositions.

As described above, various conventional components and ingredients are avoided in formulating the polymer composition of the present disclosure. For instance, in the past, various carboxylic acids, esters thereof, and salts thereof, were used as lubricants and/or mold release agents. The polymer composition of the present disclosure, however, can be formulated so as not to contain any of these components which are not food grade compliant. For instance, the polymer composition, in one aspect, can be free of montanic acid, esters of montanic acid, and montanic acid salts. In one particular embodiment, for instance, the polymer composition does not contain sodium montanate. In one embodiment, the polymer composition can be formulated to be free of all carboxylic acids, esters, and salts thereof. The polymer composition can also be formulated so as not to contain any isocyanates, epoxy resins, carbodiimides, or the like.

The polymer composition of the present disclosure can be formulated so that every component contained in the composition meets governmental regulations regarding food handling or medical applications. For example, every component contained in the polymer composition can be approved for use according to the United States Food and Drug Administration food contact standards and approved listings as found in Title 21 of the Code of Federal Regulations (as in existence in March of 2021). For example, each polymer contained within the polymer composition can be approved for food handling applications as indicated in 21 CFR 177. Each component contained in the polymer composition can also be approved for food handling applications according to 21 CFR 174 (Indirect Food Additives: General).

Each component contained within the polymer composition can also meet or exceed all food contact standards such as Regulation (EC) No. 1935/2004, 2023/2006, 10/2011, Resolution AP (89) 1, Germany BfR IX, Spain Real Decreto 847/2011, and Italy Decreto 21/3/73; and Chinese food contact standards such as GB 9685-2016.

In one embodiment, the thermoplastic matrix polymer contained in the polymer composition comprises one or more polyester polymers. The polyester polymer generally comprises a polyalkylene terephthalate polymer.

Polyalkylene terephthalate polymers suitable for use herein are derived from an aliphatic or cycloaliphatic diol, or mixtures thereof, containing from 2 to about 10 carbon atoms and an aromatic dicarboxylic acid.

The polyesters which are derived from a cycloaliphatic diol and an aromatic dicarboxylic acid are prepared by condensing either the cis- or trans-isomer (or mixtures thereof) of, for example, 1,4-cyclohexanedimethanol with the aromatic dicarboxylic acid.

Examples of aromatic dicarboxylic acids include isophthalic or terephthalic acid, 1,2-di(p-carboxyphenyl)ethane, 4,4′-dicarboxydiphenyl ether, etc., and mixtures of these. All of these acids contain at least one aromatic nucleus. Fused rings can also be present such as in 1,4- or 1,5- or 2,6-naphthalene-dicarboxylic acids. In one embodiment, the dicarboxylic acid is terephthalic acid or mixtures of terephthalic and isophthalic acid.

In one embodiment, the polyalkylene terephthalate polymer present in the polymer composition comprises a polybutylene terephthalate polymer, a polyethylene terephthalate polymer, or mixtures thereof. For example, the polymer composition may contain a polyethylene terephthalate polymer in an amount greater than about 30% by weight, such as in an amount greater than about 40% by weight, such as in an amount greater than about 50% by weight, such as in an amount greater than about 55% by weight, such as in an amount greater than about 60% by weight, such as in an amount greater than about 70% by weight. The polyethylene terephthalate polymer is generally present in an amount less than about 90% by weight, such as in an amount less than about 80% by weight.

The polymer composition may contain the polyethylene terephthalate polymer alone or in combination with other thermoplastic polymers. For instance, the polyethylene terephthalate polymer may be combined with other polyester polymers and/or a polycarbonate polymer. Other polyester polymers that may be present in the composition include a polybutylene terephthalate polymer or a polyethylene terephthalate copolymer. For instance, a polyethylene terephthalate copolymer or modified polyethylene terephthalate polymer can be produced with a modifying acid or a modifying diol.

As used herein, the terms “modifying acid” and “modifying diol” are meant to define compounds, which can form part of the acid and diol repeat units of a polyester, respectively, and which can modify a polyester to reduce its crystallinity or render the polyester amorphous. In one embodiment, however, the polyesters present in the polymer composition of the present disclosure are non-modified and do not contain a modifying acid or a modifying diol.

Examples of modifying acid components may include, but are not limited to, isophthalic acid, phthalic acid, 1,3-cyclohexanedicarboxylic acid, 1,4-cyclohexane dicarboxylic acid, 2,6-naphthaline dicarboxylic acid, succinic acid, glutaric acid, adipic acid, sebacic acid, suberic acid, 1,12-dodecanedioic acid, and the like. In practice, it is often preferable to use a functional acid derivative thereof such as the dimethyl, diethyl, or dipropyl ester of the dicarboxylic acid. The anhydrides or acid halides of these acids also may be employed where practical.

Preferred is isophthalic acid.

Examples of modifying diol components may include, but are not limited to, neopentyl glycol, 1,4-cyclohexanedimethanol, 1,2-propanediol, 1,3-propanediol, 2-Methy-1,3-propanediol, 1,4-butanediol, 1,6-hexanediol, 1,2-cyclohexanediol, 1,4-cyclohexanediol, 1,2-cyclohexanedimethanol, 1,3-cyclohexanedimethanol, 2,2,4,4-tetramethyl 1,3-cyclobutane diol, Z,8-bis(hydroxymethyltricyclo-[5.2.1.0]-decane wherein Z represents 3, 4, or 5; 1,4-Bis(2-hydroxyethoxy)benzene, 4,4′-Bis(2-hydroxyethoxy) diphenylether [Bis-hydroxyethyl Bisphenol A], 4,4′-Bis(2-hydroxyethoxy)diphenylsulfide [Bis-hydroxyethyl Bisphenol S] and diols containing one or more oxygen atoms in the chain, e.g. diethylene glycol, triethylene glycol, dipropylene glycol, tripropylene glycol, and the like. In general, these diols contain 2 to 18, preferably 2 to 8 carbon atoms. Cycloalphatic diols can be employed in their cis or trans configuration or as mixtures of both forms.

The polymer composition can optionally contain a reinforcing filler or reinforcing fibers in addition to the thermoplastic polymer matrix. The thermoplastic polymer, such as the polyester polymer, for instance, can be combined with fibrous fillers in order to increase the modulus and/or tensile strength of parts and products made from the reinforced composition.

Reinforcing fibers suitable for use include mineral fibers, such as glass fibers, polymer fibers, in particular organic high-modulus fibers, such as aramid fibers, or metal fibers, such as steel fibers, or carbon fibers or natural fibers, fibers from renewable resources.

These fibers may be in modified or unmodified form, e.g. provided with a sizing, or chemically treated, in order to improve adhesion to the plastic. Glass fibers are particularly preferred.

Glass fibers are provided with a sizing to protect the glass fiber, to smooth the fiber but also to improve the adhesion between the fiber and the matrix material. A sizing usually comprises silanes, film forming agents, lubricants, wetting agents, adhesive agents optionally antistatic agents and plasticizers, emulsifiers and optionally further additives.

Specific examples of silanes are aminosilanes, e.g. 3-trimethoxysilylpropylamine, N-(2-aminoethyl)-3-aminopropyltrimethoxy-silane, N-(3-trimethoxysilanylpropyl)ethane-1,2-diamine, 3-(2-aminoethyl-amino)propyltrimethoxysilane, N-[3-(trimethoxysilyl)propyl]-1,2-ethane-diamine.

Film forming agents are for example polyvinylacetates, polyesters and polyurethanes. Sizings based on polyurethanes may be used advantageously.

The reinforcing fibers may be compounded into the polymer matrix, for example in an extruder or kneader.

According to one embodiment, the molding composition of the present disclosure comprises at least one reinforcing fiber which is a mineral fiber, preferably a glass fiber, more preferably a coated or impregnated glass fiber.

Fiber diameters can vary depending upon the particular fiber used and whether the fiber is in either a chopped or a continuous form. The fibers, for instance, can have a diameter of from about 5 μm to about 100 μm, such as from about 5 μm to about 50 μm, such as from about 5 μm to about 15 μm. The length of the fibers can vary depending upon the particular application. For instance, the fibers can have a length of greater than about 100 microns, such as greater than about 200 microns, such as greater than about 300 microns, such as greater than about 350 microns. The length of the fibers can generally be less than about 1,000 microns, such as less than about 800 microns, such as less than about 600 microns, such as less than about 500 microns. Once incorporated into the polymer composition and molded into an article, the fiber length can decrease. For instance, the average fiber length in the final product can be from about 100 microns to about 400 microns, such as from about 100 microns to about 300 microns.

In general, reinforcing fibers or fillers can be present in the polymer composition in amounts sufficient to increase the tensile strength of the composition. The reinforcing fibers or fillers, for example, can be present in the polymer composition in an amount greater than about 5% by weight, such as in an amount greater than about 10% by weight, such as in an amount greater than about 15% by weight, such as in an amount greater than about 20% by weight, such as in an amount greater than about 25% by weight, such as in an amount greater than about 30% by weight. The reinforcing fibers are generally present in an amount less than about 55% by weight, such as in an amount less than about 50% by weight, such as in an amount less than about 45% by weight, such as in an amount less than about 40% by weight, such as in an amount less than about 35% by weight, such as in an amount less than about 30% by weight.

In accordance with the present disclosure, the polymer composition contains one or more mold release agents that are added in an amount sufficient to lower ejection forces of parts from a mold, such as a mold during injection molding. The mold release agent of the present disclosure is also believed to synergistically work with at least one nucleant for increasing crystallization rates. Increasing crystallization rates can significantly improve cycle times and increase production.

In one aspect, the polymer composition only contains a single mold release agent. The mold release agent can comprise, for instance, a polyethylene wax. In one aspect, the polyethylene wax can comprise an oxidized polyethylene wax.

The polarity of the mold release agent can vary depending upon the particular application and the desired result. The polarity, for instance, can be indicated by the acid value of the mold release agent. The acid value of the mold release agent, for instance, can generally be greater than about 10 KOH/g, such as greater than about 15 KOH/g, such as greater than about 20 KOH/g. The acid value is generally less than about 50 KOH/g, such as less than about 40 KOH/g, such as less than about 30 KOH/g, such as less than about 25 KOH/g.

In one aspect, a food grade compliant oxidized polyethylene wax is used that has a relatively high viscosity. For instance, the oxidized polyethylene wax can have a viscosity of greater than about 1,000 mPa-s, such as greater than about 1,100 mPa-s, such as greater than about 1,200 mPa-s, such as greater than about 1,300 mPa-s, such as greater than about 1,400 mPa-s, such as greater than about 1,500 mPa-s, such as greater than about 1,600 mPa-s, such as greater than about 1,700 mPa-s, and generally less than about 3,000 mPa-s, such as less than about 2,000 mPa-s. The viscosity can be measured according to DIN Test 53019 at 140° C.

The oxidized polyethylene wax or mold release agent can have a density of greater than 0.96 g/cm³, such as greater than about 0.97 g/cm³, such as greater than about 0.975 g/cm³, and less than about 0.99 g/cm³. The oxidized polyethylene wax can display a drop point of greater than about 110° C., such as greater than about 115° C., such as greater than about 120° C., and less than about 135° C., such as less than about 130° C., such as less than about 120° C. when tested according to ISO Test 2176.

The mold release agent or oxidized polyethylene wax is generally present in the polymer composition in an amount less than about 2% by weight, such as in an amount less than about 1.5% by weight, such as in an amount less than about 1% by weight, such as in an amount less than about 0.5% by weight. The oxidized polyethylene wax is present in the polymer composition in an amount greater than about 0.01% by weight, such as in an amount greater than about 0.1% by weight, such as in an amount greater than about 0.2% by weight.

The polymer composition also contains at least one nucleant that together with the mold release agent dramatically increases crystallization rates.

In accordance with the present disclosure, the mold release agent as described above is combined with one or more nucleants. The nucleant, for instance, may comprise a mineral nucleant such as talc or silica, an ionomer, a bicarbonate, a benzoate, a phosphate ester, or mixtures thereof. One or more nucleants can be present in the polymer composition generally in an amount less than about 2% by weight, such as in an amount less than about 1.5% by weight, such as in an amount less than about 1.3% by weight, such as in an amount less than about 1% by weight, such as in an amount less than about 0.8% by weight, such as in an amount less than about 0.5% by weight, such as in an amount less than about 0.4% by weight. One or more nucleants can be present in the polymer composition generally in an amount greater than about 0.01% by weight, such as in an amount greater than about 0.08% by weight, such as in an amount greater than about 0.1% by weight, such as in an amount greater than about 0.15% by weight, such as in an amount greater than about 0.2% by weight. In one aspect, a nucleant or blend of nucleants can be selected based upon the mold release agent used, the desired crystallization rates, and the end use application.

In one aspect, the nucleant comprises a mineral nucleant. The mineral nucleant can comprise talc, clay particles such as bentonite or calcined kaolin, silica, or the like. The mineral nucleant can have an average particle size of generally less than about 10 microns, such as less than about 8 microns, such as less than about 5 microns, such as less than about 3 microns, such as less than about 2 microns, such as less than about 1 micron. The average particle size is generally greater than about 0.001 microns, such as greater than about 0.1 microns, such as greater than about 0.5 microns.

When talc particles are used, the talc particles contained in the polymer composition generally comprise uncoated talc particles that may or may not include a surface treatment. In one aspect, the talc particles have a surface that is hydrophobic in nature. The talc particles can also have a plate-like structure. For instance, the talc particles can have an aspect ratio of greater than about 2, such as greater than about 4, such as greater than about 6, and less than about 100, such as less than about 20.

In one aspect, the mineral nucleant can comprise silica particles, such as fumed silica particles. The silica particles, for instance, can have a BET surface area of greater than about 20 m²/g, such as greater than about 30 m²/g, such as greater than about 35 m²/g, and less than about 100 m²/g, such as less than about 70 m²/g, such as less than about 65 m²/g. The silica particles can be greater than about 99.5% pure, such as greater than about 99.8% pure. The fumed silica particles, in one aspect, have an average particle size of less than about 2 microns, such as less than about 1 micron, such as less than about 0.5 microns, such as less than about 0.1 microns, such as even less than about 0.07 microns, and greater than about 0.001 microns, such as greater than about 0.01 microns.

In another aspect, the nucleant can comprise an ionomer, such as a sodium ionomer. The ionomer, for instance, can comprise an ionomer of an ethylene acid copolymer. The ionomer can have a density of from about 0.93 g/cc to about 0.97 g/cc, such as from about 0.94 g/cc to about 0.96 g/cc when tested according to ISO Test 1183. The ionomer can have a melt flow rate of less than about 1.5 g/10 min, such as less than about 1 g/10 min, and greater than about 0.5 g/10 min when tested according to ISO Test 1133 at a load 2.16 kg and at a temperature of 190° C. In one aspect, the ionomer comprises a copolymer of ethylene and acrylic acid containing from about 12% by weight to about 18% by weight acrylic acid units and neutralized with sodium.

In still another aspect, the nucleant can comprise a bicarbonate or a benzoate. The bicarbonate, for instance, can comprise sodium bicarbonate. The benzoate, on the other hand, can comprise an alkali benzoate, such as sodium benzoate. The sodium benzoate or sodium bicarbonate can have a relatively high surface to weight ratio. The sodium benzoate or sodium bicarbonate, for instance, can have an average particle size of less than about 2 microns, such as less than about 1 micron, such as less than about 0.5 microns, such as less than about 0.1 microns, and greater than about 0.001 microns, such as greater than about 0.01 microns.

In still another embodiment, the nucleant may comprise a phosphate ester. Examples of phosphate esters include methylen-bis(4,6-di-t-butylphenyl)phosphate sodium salt or aluminium hydroxy-bis[2,4,8,10-tetrakis(1,1-dimethylethyl)-6-hydroxy-12H-dibenzo-[d,g]-dioxa-phoshocin-6-oxidato]). In one aspect, the phosphate ester can be a mixture identified under CAS No. 85209-93-4.

As described above, the mold release agent in combination with the nucleant can dramatically and unexpectedly improve the crystallization rate of the composition while still being food grade compliant. For instance, the difference between the time to an onset of crystallization and the time to reach the isothermal crystallization temperature can be less than about 3 mins., such as less than about 2.75 mins., such as less than about 2.5 mins., such as less than about 2.25 mins., such as less than about 2 mins., such as less than about 1.75 mins., such as less than about 1.5 mins., such as less than about 1.25 mins., such as even less than about 1 min., and greater than about 0.25 mins., such as greater than about 0.5 mins.

The polymer composition may also contain at least one stabilizer. The stabilizer may comprise an antioxidant, a light stabilizer such as an ultraviolet light stabilizer, a thermal stabilizer, and the like.

Sterically hindered phenolic antioxidant(s) may be employed in the composition. Examples of such phenolic antioxidants include, for instance, calcium bis(ethyl 3,5-di-tert-butyl-4-hydroxybenzylphosphonate) (Irganox® 1425); terephthalic acid, 1,4-dithio-,S,S-bis(4-tert-butyl-3-hydroxy-2,6-dimethylbenzyl) ester (Cyanox® 1729); triethylene glycol bis(3-tert-butyl-4-hydroxy-5-methylhydrocinnamate); hexamethylene bis(3,5-di-tert-butyl-4-hydroxyhydrocinnamate (Irganox® 259); 1,2-bis(3,5,di-tert-butyl-4-hydroxyhydrocinnamoyl)hydrazide (Irganox® 1024); 4,4′-di-tert-octyldiphenamine (Naugalube® 438R); phosphonic acid, (3,5-di-tert-butyl-4-hydroxybenzyl)-, dioctadecyl ester (Irganox® 1093); 1,3,5-trimethyl-2,4,6-tris(3′,5′-di-tert-butyl-4′ hydroxybenzyl)benzene (Irganox® 1330); 2,4-bis(octylthio)-6-(4-hydroxy-3,5-di-tert-butylanilino)-1,3,5-triazine (Irganox® 565); isooctyl 3-(3,5-di-tert-butyl-4-hydroxyphenyl)propionate (Irganox® 1135); octadecyl 3-(3,5-di-tert-butyl-4-hydroxyphenyl)propionate (Irganox® 1076); 3,7-bis(1,1,3,3-tetramethylbutyl)-10H-phenothiazine (Irganox® LO 3); 2,2′-methylenebis(4-methyl-6-tert-butylphenol)monoacrylate (Irganox® 3052); 2-tert-butyl-6-[1-(3-tert-butyl-2-hydroxy-5-methylphenyl)ethyl]-4-methylphenyl acrylate (Sumilizer® TM 4039); 2-[1-(2-hydroxy-3,5-di-tert-pentylphenyl)ethyl]-4,6-di-tert-pentylphenyl acrylate (Sumilizer® GS); 1,3-dihydro-2H-Benzimidazole (Sumilizer® MB); 2-methyl-4,6-bis[(octylthio)methyl]phenol (Irganox® 1520); N,N′-trimethylenebis-[3-(3,5-di-tert-butyl-4-hydroxyphenyl)propionamide (Irganox® 1019); 4-n-octadecyloxy-2,6-diphenylphenol (Irganox® 1063); 2,2′-ethylidenebis[4,6-di-tert-butylphenol](Irganox® 129); N N′-hexamethylenebis(3,5-di-tert-butyl-4-hydroxyhydrocinnamamide) (Irganox® 1098); diethyl (3,5-di-tert-butyl-4-hydroxybenxyl)phosphonate (Irganox® 1222); 4,4′-di-tert-octyldiphenylamine (Irganox® 5057); N-phenyl-1-napthalenamine (Irganox® L 05); tris[2-tert-butyl-4-(3-ter-butyl-4-hydroxy-6-methylphenylthio)-5-methyl phenyl]phosphite (Hostanox® OSP 1); zinc dinonyidithiocarbamate (Hostanox® VP-ZNCS 1); 3,9-bis[1,1-diimethyl-2-[(3-tert-butyl-4-hydroxy-5-methylphenyl)propionyloxy]ethyl]-2,4,8,10-tetraoxaspiro[5.5]undecane (Sumilizer® AG80); pentaerythrityl tetrakis[3-(3,5-di-tert-butyl-4-hydroxyphenyl)propionate] (Irganox® 1010); ethylene-bis(oxyethylene) bis[3-(5-tert-butyl-4-hydroxy-m-tolyl)-propionate (Irganox® 245); 3,5-di-tert-butyl-4-hydroxytoluene (Lowinox BHT, Chemtura) and so forth.

Some examples of suitable sterically hindered phenolic antioxidants for use in the present composition are triazine antioxidants having the following general formula:

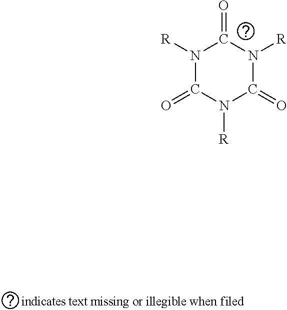

wherein, each R is independently a phenolic group, which may be attached to the triazine ring via a C₁ to C₅ alkyl or an ester substituent. Preferably, each R is one of the following formula (I)-(III):

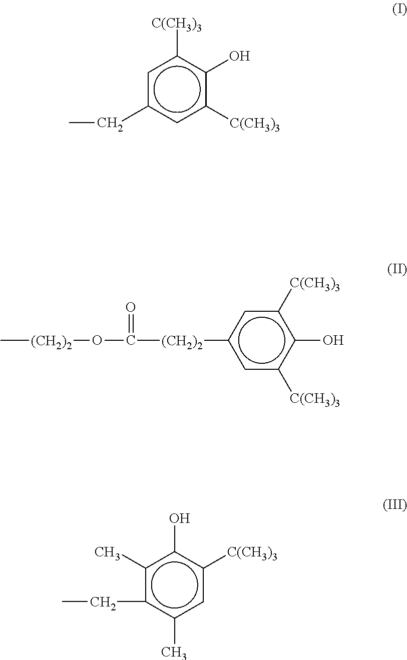

Commercially available examples of such triazine-based antioxidants may be obtained from American Cyanamid under the designation Cyanox® 1790 (wherein each R group is represented by the Formula 111) and from Ciba Specialty Chemicals under the designations Irganox® 3114 (wherein each R group is represented by the Formula I) and Irganox® 3125 (wherein each R group is represented by the Formula II).

Sterically hindered phenolic antioxidants may constitute from about 0.01 wt. % to about 3 wt. %, in some embodiments from about 0.05 wt. % to about 1 wt. %, and in some embodiments, from about 0.05 wt. % to about 0.1 wt. % of the entire stabilized polymer composition. In one embodiment, for instance, the antioxidant comprises pentaerythrityl tetrakis[3-(3,5-di-tert-butyl-4-hydroxyphenyl)propionate.

Hindered amine light stabilizers (“HALS”) may be employed in the composition to inhibit degradation of the polymer composition and thus extend its durability. Suitable HALS compounds may be derived from a substituted piperidine, such as alkyl-substituted piperidyl, piperidinyl, piperazinone, alkoxypiperidinyl compounds, and so forth. For example, the hindered amine may be derived from a 2,2,6,6-tetraalkylpiperidinyl. Regardless of the compound from which it is derived, the hindered amine is typically an oligomeric or polymeric compound having a number average molecular weight of about 1,000 or more, in some embodiments from about 1000 to about 20,000, in some embodiments from about 1500 to about 15,000, and in some embodiments, from about 2000 to about 5000. Such compounds typically contain at least one 2,2,6,6-tetraalkylpiperidinyl group (e.g., 1 to 4) per polymer repeating unit.

Without intending to be limited by theory, it is believed that high molecular weight hindered amines are relatively thermostable and thus able to inhibit light degradation even after being subjected to extrusion conditions. One particularly suitable high molecular weight hindered amine has the following general structure:

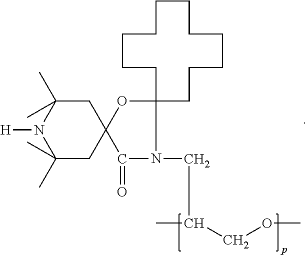

wherein, p is 4 to 30, in some embodiments 4 to 20, and in some embodiments 4 to 10. This oligomeric compound is commercially available from Clariant under the designation Hostavin® N30 and has a number average molecular weight of 1200.

Another suitable high molecular weight hindered amine has the following structure:

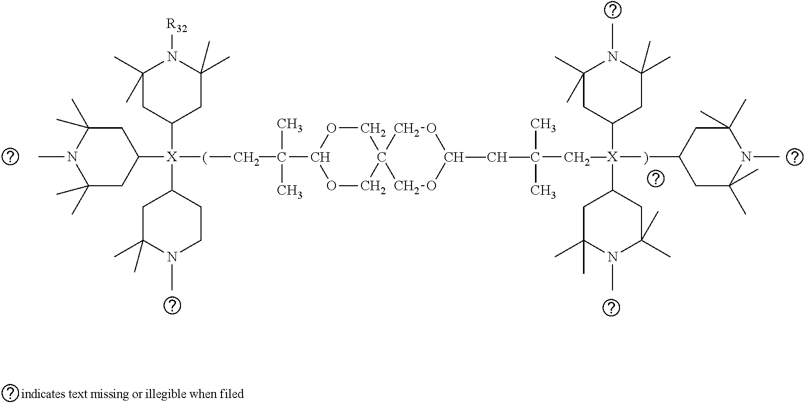

wherein, n is from 1 to 4 and R₃₀ is independently hydrogen or CH₃. Such oligomeric compounds are commercially available from Adeka Palmarole SAS (joint venture between Adeka Corp. and Palmarole Group) under the designation ADK STAB® LA-63 (R₃₀ is CH₃) and ADK STAB® LA-68 (R₃₀ is hydrogen).

Other examples of suitable high molecular weight hindered amines include, for instance, an oligomer of N-(2-hydroxyethyl)-2,2,6,6-tetramethyl-4-piperidinol and succinic acid (Tinuvin® 622 from Ciba Specialty Chemicals, MW=4000); oligomer of cyanuric acid and N,N-di(2,2,6,6-tetramethyl-4-piperidyl)-hexamethylene diamine; poly((6-morpholine-S-triazine-2,4-diyl)(2,2,6,6-tetramethyl-4-piperidinyl)-iminohexamethylene-(2,2,6,6-tetramethyl-4-piperidinyl)-imino) (Cyasorb® UV 3346 from Cytec, MW=1600); polymethylpropyl-3-oxy-[4(2,2,6,6-tetramethyl)-piperidinylysiloxane (Uvasil® 299 from Great Lakes Chemical, MW=1100 to 2500); copolymer of α-methylstyrene-N-(2,2,6,6-tetramethyl-4-piperidinyl)maleimide and N-stearyl maleimide; 2,4,8,10-tetraoxaspiro[5.5]undecane-3,9-diethanol tetramethyl-polymer with 1,2,3,4-butanetetracarboxylic acid; and so forth. Still other suitable high molecular weight hindered amines are described in U.S. Pat. No. 5,679,733 to Malik, et al. and U.S. Pat. No. 6,414,155 to Sassi, et al., which are incorporated herein in their entirety by reference thereto for all purposes.

In addition to the high molecular hindered amines, low molecular weight hindered amines may also be employed in the composition. Such hindered amines are generally monomeric in nature and have a molecular weight of about 1000 or less, in some embodiments from about 155 to about 800, and in some embodiments, from about 300 to about 800.

Specific examples of such low molecular weight hindered amines may include, for instance, bis-(2,2,6,6-tetramethyl-4-piperidyl) sebacate (Tinuvin® 770 from Ciba Specialty Chemicals, MW=481); bis-(1,2,2,6,6-pentamethyl-4-piperidinyl)-(3,5-ditert·butyl-4-hydroxybenzyl)butyl-propane dioate; bis-(1,2,2,6,6-pentamethyl-4-piperidinyl)sebacate; 8-acetyl-3-dodecyl-7,7,9,9-tetramethyl-1,3,8-triazaspiro-(4,5)-decane-2,4-dione, butanedioic acid-bis-(2,2,6,6-tetramethyl-4-piperidinyl) ester; tetrakis-(2,2,6,6-tetramethyl-4-piperidyl)-1,2,3,4-butane tetracarboxylate; 7-oxa-3,20-diazadispiro(5.1.11.2) heneicosan-20-propanoic acid, 2,2,4,4-tetramethyl-21-oxo, dodecyl ester; N-(2,2,6,6-tetramethyl-4-piperidinyl)-N′-amino-oxamide; o-t-amyl-o-(1,2,2,6,6-pentamethyl-4-piperidinyl)-monoperoxi-carbonate; β-alanine, N-(2,2,6,6-tetramethyl-4-piperidinyl), dodecylester; ethanediamide, N-(1-acetyl-2,2,6,6-tetramethylpiperidinyl)-N′-dodecyl; 3-dodecyl-1-(2,2,6,6-tetramethyl-4-piperidinyl)-pyrrolidin-2,5-dione; 3-dodecyl-1-(1,2,2,6,6-pentamethyl-4-piperidinyl)-pyrrolidin-2,5-dione; 3-dodecyl-1-(1-acetyl,2,2,6,6-tetramethyl-4-piperidinyl)-pyrrolidin-2,5-dione, (Sanduvar® 3058 from Clariant, MW=448.7); 4-benzoyloxy-2,2,6,6-tetramethylpiperidine; 1-[2-(3,5-di-tert-butyl-4-hydroxyphenylpropionyloxy)ethyl]-4-(3,5-di-tert-butyl-4-hydroxylphenyl propionyloxy)-2,2,6,6-tetramethyl-piperidine; 2-methyl-2-(2″,2″,6″,6″-tetramethyl-4″-piperidinylamino)-N-(2′,2′,6′,6′-tetra-methyl-4′-piperidinyl)propionylamide; 1,2-bis-(3,3,5,5-tetramethyl-2-oxo-piperazinyl)ethane; 4-oleoyloxy-2,2,6,6-tetramethylpiperidine; and combinations thereof. Other suitable low molecular weight hindered amines are described in U.S. Pat. No. 5,679,733 to Malik, et al.

The hindered amines may be employed singularly or in combination in any amount to achieve the desired properties, but typically constitute from about 0.01 wt. % to about 4 wt. % of the polymer composition.

UV absorbers, such as benzotriazoles or benzopheones, may be employed in the composition to absorb ultraviolet light energy. Suitable benzotriazoles may include, for instance, 2-(2-hydroxyphenyl)benzotriazoles, such as 2-(2-hydroxy-5-methylphenyl)benzotriazole; 2-(2-hydroxy-5-tert-octylphenyl)benzotriazole (Cyasorb® UV 5411 from Cytec); 2-(2-hydroxy-3,5-di-tert-butylphenyl)-5-chlorobenzo-triazole; 2-(2-hydroxy-3-tert-butyl-5-methylphenyl)-5-chlorobenzotriazole; 2-(2-hydroxy-3,5-dicumylphenyl)benzotriazole; 2,2′-methylenebis(4-tert-octyl-6-benzo-triazolylphenol); polyethylene glycol ester of 2-(2-hydroxy-3-tert-butyl-5-carboxyphenyl)benzotriazole; 2-[2-hydroxy-3-(2-acryloyloxyethyl)-5-methylphenyl]-benzotriazole; 2-[2-hydroxy-3-(2-methacryloyloxyethyl)-5-tert-butylphenyl]benzotriazole; 2-[2-hydroxy-3-(2-methacryloyloxyethyl)-5-tert-octylphenyl]benzotriazole; 2-[2-hydroxy-3-(2-methacryloyloxyethyl)-5-tert-butylphenyl]-5-chlorobenzotriazole; 2-[2-hydroxy-5-(2-methacryloyloxyethyl)phenyl]benzotriazole; 2-[2-hydroxy-3-tert-butyl-5-(2-methacryloyloxyethyl)phenyl]benzotriazole; 2-[2-hydroxy-3-tert-amyl-5-(2-methacryloyloxyethyl)phenyl]benzotriazole; 2-[2-hydroxy-3-tert-butyl-5-(3-methacryloyloxypropyl)phenyl]-5-chlorobenzotriazole; 2-[2-hydroxy-4-(2-methacryloyloxymethyl)phenyl]benzotriazole; 2-[2-hydroxy-4-(3-methacryloyloxy-2-hydroxypropyl)phenyl]benzotriazole; 2-[2-hydroxy-4-(3-methacryloyloxypropyl)phenyl]benzotriazole; and combinations thereof.

Exemplary benzophenone light stabilizers may likewise include 2-hydroxy-4-dodecyloxybenzophenone; 2,4-dihydroxybenzophenone; 2-(4-benzoyl-3-hydroxyphenoxy)ethyl acrylate (Cyasorb® UV 209 from Cytec); 2-hydroxy-4-n-octyloxy)benzophenone (Cyasorb® 531 from Cytec); 2,2′-dihydroxy-4-(octyloxy)benzophenone (Cyasorb® UV 314 from Cytec); hexadecyl-3,5-bis-tert-butyl-4-hydroxybenzoate (Cyasorb® UV 2908 from Cytec); 2,2′-thiobis(4-tert-octylphenolato)-n-butylamine nickel(II) (Cyasorb® UV 1084 from Cytec); 3,5-di-tert-butyl-4-hydroxybenzoic acid, (2,4-di-tert-butylphenyl)ester (Cyasorb® 712 from Cytec); 4,4′-dimethoxy-2,2′-dihydroxybenzophenone (Cyasorb® UV 12 from Cytec); and combinations thereof.

When employed, UV absorbers may constitute from about 0.01 wt. % to about 4 wt. % of the entire polymer composition.

In one embodiment, the polymer composition may contain a blend of stabilizers that produce ultraviolet resistance and color stability. The combination of stabilizers may allow for products to be produced that have bright and fluorescent colors. In addition, bright colored products can be produced without experiencing significant color fading over time. In one embodiment, for instance, the polymer composition may contain a combination of a benzotriazole light stabilizer and a hindered amine light stabilizer, such as an oligomeric hindered amine.

In one embodiment, an amide wax may be present in the polymer composition. Amide waxes, for instance, may be employed that are formed by reaction of a fatty acid with a monoamine or diamine (e.g., ethylenediamine) having 2 to 18, especially 2 to 8, carbon atoms. For example, ethylenebisamide wax, which is formed by the amidization reaction of ethylene diamine and a fatty acid, may be employed. The fatty acid may be in the range from C₁₂ to C₃₀, such as from stearic acid (C₁₈ fatty acid) to form ethylenebisstearamide wax. Ethylenebisstearamide wax is commercially available from Lonza, Inc. under the designation Acrawax® C, which has a discrete melt temperature of 142° C. Other ethylenebisamides include the bisamides formed from lauric acid, palmitic acid, oleic acid, linoleic acid, linolenic acid, oleostearic acid, myristic acid and undecalinic acid. Still other suitable amide waxes are N-(2-hydroxyethyl)12-hydroxystearamide and N,N′-(ethylene bis)12-hydroxystearamide.

In addition to the above components, the polymer composition may include various other ingredients. Colorants that may be used include any desired inorganic pigments, such as titanium dioxide, ultramarine blue, cobalt blue, and other organic pigments and dyes, such as phthalocyanines, anthraquinones, and the like. Other colorants include carbon black or various other polymer-soluble dyes. The colorants can generally be present in the composition in an amount up to about 2 percent by weight.

The compositions of the present disclosure can be compounded and formed into a polymer article using any technique known in the art. For instance, the respective composition can be intensively mixed to form a substantially homogeneous blend. The blend can be melt kneaded at an elevated temperature, such as a temperature that is higher than the melting point of the polymer utilized in the polymer composition but lower than the degradation temperature. Alternatively, the respective composition can be melted and mixed together in a conventional single or twin screw extruder. Preferably, the melt mixing is carried out at a temperature ranging from 150 to 300° C., such as from 200 to 280° C., such as from 220 to 270° C. or 240 to 260° C. However, such processing should be conducted for each respective composition at a desired temperature to minimize any polymer degradation.

After extrusion, the compositions may be formed into pellets. The pellets can be molded into polymer articles by techniques known in the art such as injection molding, thermoforming, blow molding, rotational molding and the like. According to the present disclosure, the polymer articles can demonstrate excellent mechanical properties and fast cycle times.

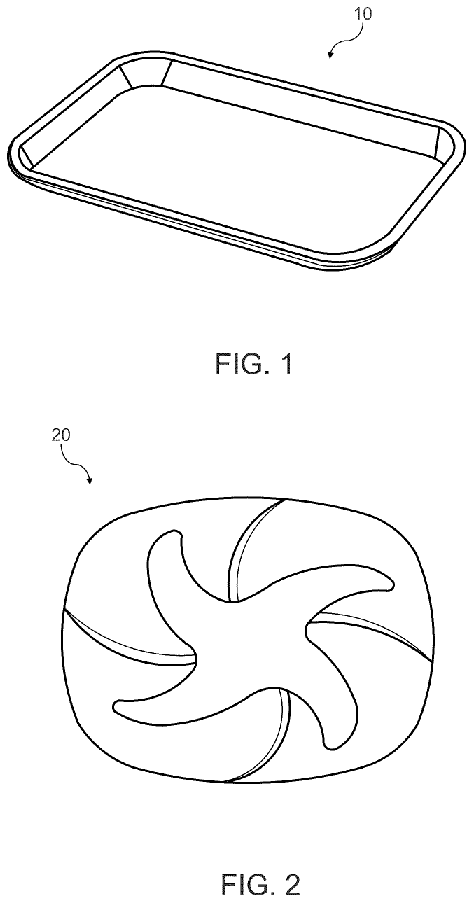

The polymer composition of the present disclosure is particularly well suited to molding all different types of products, parts, and components that are intended to contact food items or comprise a portion of food equipment. For example, referring to FIG. 1, a food tray 10 is shown made in accordance with the present disclosure.

Alternatively, the polymer composition can be used to produce a part contained in food handling equipment. For instance, referring to FIG. 2, a drip pan 20 is shown. The drip pan 20 can be used in any suitable food heating device, such as an air fryer, a toaster oven, or the like.

The present disclosure may be better understood with reference to the following examples.

### EXAMPLES

The following examples are given below by way of illustration and not by way of limitation. The following experiments were conducted in order to show some of the benefits and advantages of the present invention.

### Example No. 1

Various polymer compositions were formulated, each containing a polyethylene terephthalate polymer combined with glass fibers in an amount of 30% by weight. The polymer compositions also contained a mold release agent comprising an oxidized polyethylene wax in accordance with the present disclosure. One formulation contained a montanic acid salt for purposes of comparison.

Various different nucleating agents were added and tested in combination with the oxidized polyethylene wax.

The following compositions were formulated:

TABLE NO 1

| | Sample No. | | | | | | | |
|---|---|---|---|---|---|---|---|---|
| Component | 1 | 2 | 3 | 4 | 5 | 6 | 7 | 8 |
| PET | 65.90 | 66.20 | 65.90 | 65.90 | 65.90 | 65.90 | 65.90 | 65.90 |
| PET Grind | 2.00 | 2.00 | 2.00 | 2.00 | 2.00 | 2.00 | 2.00 | 2.00 |
| Glass fiber | 30.00 | | | | | | | |
| Glass fiber | | 30.00 | 30.00 | 30.00 | 30.00 | 30.00 | 30.00 | 30.00 |
| Oxidized PE wax | 0.30 | 0.30 | 0.30 | 0.30 | 0.30 | 0.30 | 0.30 | 0.30 |
| Sodium salt of montanic acid | 0.30 | | | | | | | |
| Talc | | | 0.30 | | | | | |
| Fumed Silica | | | | | | | 0.30 | |
| Sodium Ionomer of ethylene acid | | | | 0.30 | | | | |
| copolymer. Clear pellets. | | | | | | | | |
| Density~0.95 g/cm3, Tm~92° C. | | | | | | | | |
| MFR (190° C./2.16 kg)~0.9 g/10 min | | | | | | | | |
| Sodium benzoate, White powder | | | | | | 0.30 | | |
| Sodium bicarbonate | | | | | 0.30 | | | |
| 70-90% (Phosphate ester | | | | | | | | 0.30 |
| compound, CAS 85209-93-4), | | | | | | | | |
| White powder | | | | | | | | |
| Tm > 210° C. 0.05-0.3% dosage | | | | | | | | |
| Black masterbatch | 1.50 | 1.50 | 1.50 | 1.50 | 1.50 | 1.50 | 1.50 | 1.50 |
| | 100.0 | 100.0 | 100.0 | 100.0 | 100.0 | 100.0 | 100.0 | 100.0 |

The polymer formulations above were tested for various mechanical properties. Tensile properties were tested according to ISO Test 527:2012. Notched Charpy impact strength was tested according to ISO Test 179-1:2010. The test was run using a Type A notch (0.25 mm base radius) and Type 1 specimen size (length of 80 mm, width of 10 mm, and thickness of 4 mm). The test was conducted at a temperature of 2300. The following results were obtained:

TABLE NO 2

| Sample No. | | 1 | 2 | 3 | 4 | 5 | 6 | 7 | 8 |
|---|---|---|---|---|---|---|---|---|---|
| Viscosity Number | ml/g | 69 | 94 | 79 | 79.5 | 62 | 69.5 | 79.5 | 86 |
| Tensile Modulus | MPa | 11340 | 11090 | 11160 | 11385 | 11755 | 11980 | 10920 | 11835 |
| Break Strength | MPa | 172 | 173 | 170 | 171 | 174 | 161 | 160 | 179 |
| Break strain | % | 2.1 | 2.4 | 2.4 | 2.3 | 2.1 | 1.7 | 2.2 | 2.2 |
| Charpy | kJ/m² | 42 | 47.5 | 47 | 47 | 39 | 30 | 42 | 43 |
| Unnotched | | | | | | | | | |
| Charpy Notched | kJ/m² | 9 | 9 | 8.5 | 9.5 | 9.5 | 11.5 | 7 | 9 |

The crystallization properties of the polymer compositions were also evaluated using standard differential scanning calorimetry (DSC). The following parameters were used to determine crystallization onset temperature, crystallization temperature, and melting temperature:

### Method

Start temperature: −10° C.
First heating to 280° C. at 10° C./min
First cooling to −10° C. at 10° C./min
Second heating to 280° C. at 10° C./min
Holding time of 5 min at each temperature

TABLE NO 3

| Sample No. | | 1 | 2 | 3 | 4 | 5 | 6 | 7 | 8 |
|---|---|---|---|---|---|---|---|---|---|
| Crystallization | ° C. | 219 | 213.5 | 216 | 216 | 223 | 223.5 | 214 | 215.5 |
| onset temperature | | | | | | | | | |
| Crystallization | ° C. | 215 | 208.5 | 212 | 213 | 215.5 | 218.5 | 209 | 210.5 |
| temperature | | | | | | | | | |
| Melting | ° C. | 249 | 247.5 | 249 | 249 | 250 | 251 | 247.5 | 248 |
| temperature | | | | | | | | | |
| (second heating) | | | | | | | | | |

The isothermal crystallization rates of each polymer composition was also determined using DSC. The following method was used:

Method [Two Measurements for Each Grade were Done]
Start temperature: 25° C.
Heating to 280° C. at 40° C./min, holding for 5 min
Cooling down to the isothermal crystallization temperature of 230° C. at 20° C./min, holding for 10 min
Cooling down to room temperature at 20° C./min

TABLE NO 4

| Sample No. | | 1 | 2 | 3 | 4 | 5 | 6 | 7 | 8 |
|---|---|---|---|---|---|---|---|---|---|
| t₁ | min | 14.27/14.27 | 14.27/14.27 | 14.27/14.27 | 14.27/14.27 | 14.27/14.27 | 14.27/14.27 | 14.28/14.28 | 14.26/14.26 |
| t₂ | min | 15.5/15.5 | 18/18 | 15.2/15.2 | 18/18 | 14.6/14.6 | 14.5/14.5 | 18/18 | 17/17 |
| t₃ | min | 17.8/17.8 | 21.58/21.41 | 17.54/17.47 | 21.80/21.85 | 15.88/15.87 | 15.86/15.78 | 21.47/21.29 | 20/20 |
| t₂ − t₁ | min | 1.23/1.23 | 3.73/3.73 | 0.93/0.93 | 3.74/3.74 | 0.33/0.33 | 0.23/0.23 | 3.72/3.72 | 2.74/2.74 |
| t₃ − t₂ | min | 2.3/2.3 | 3.58/3.41 | 2.34/2.27 | 3.8/3.85 | 1.28/1.27 | 1.36/1.28 | 3.47/3.29 | 3/3 |
| t₂ − t₁ | min | 1.23 | 3.73 | 0.93 | 3.74 | 0.33 | 0.23 | 3.72 | 2.74 |
| (avg.) | | | | | | | | | |
| t₃ − t₂ | min | 2.3 | 3.5 | 2.3 | 3.8 | 1.27 | 1.32 | 3.38 | 3 |
| (avg.) | | | | | | | | | |

Total time to reach isothermal crystallization temperature: t₁
Total time to the point where crystallization starts/crystallization onset: t₂
Total time to the point where crystallization peak maximum is observed: t₃
Induction time (time elapsed at 230° C. before crystallization starts): t₂ − t₁
Time at 230° C. from crystallization onset to crystallization peak maximum at 230° C.: t₃ − t₂

As shown above, very fast crystallization rates were achieved according to the present disclosure.

### Example No. 2

Example No. 1 was repeated except a different oxidized polyethylene wax was used as the mold release agent. In Example No. 1, the oxidized polyethylene wax was a copolymer wax having a drop point of from 100° to 108° C. when tested according to ISO Test 2176, had a density of from 0.94 to 0.96 g/cm³ when tested according to ISO Test 1183, and had a viscosity of about 350 mPa-s when tested according to DIN Test 53019 at 120° C. In this example, the oxidized polyethylene wax had a higher viscosity. In particular, the oxidized polyethylene wax had a drop point of 120° C. to 125° C. when tested according to ISO Test 2176, had a viscosity of about 1,800 mPa-s when tested according to DIN Test 53019 at 140° C., and had a density of about 0.98 g/cm³ when tested according to ISO Test 1183.

The oxidized polyethylene wax was combined with talc, an ionomer, or sodium bicarbonate as a nucleant. The following formulations were produced:

TABLE NO. 5

| | Sample No. | | |
|---|---|---|---|
| | | 10 | 11 |
| | 9 | Sodium | Sodium |
| RM description | Talc | Ionomer | bicarbonate |
| PET | 65.90 | 65.90 | 65.90 |
| PET Grind | 2.00 | 2.00 | 2.00 |
| Glass fiber | 30.00 | 30.00 | 30.00 |
| Oxidized polyethylene wax | 0.30 | 0.30 | 0.30 |
| Talc | 0.30 | | |
| Sodium Ionomer of ethylene acid | | 0.30 | |
| copolymer. Clear pellets. | | | |
| Density ~ 0.95 g/cm3, Tm ~ 92° C. | | | |
| MFR (190° C./2.16 kg) ~ 0.9 g/10 min | | | |
| Sodium bicarbonate | | | 0.30 |
| Black Masterbatch | 1.50 | 1.50 | 1.50 |
| | 100.0 | 100.0 | 100.0 |

The above formulations were tested using the same test procedures as described in Example No. 1. The following results were obtained:

TABLE NO. 6

| | | | |
|---|---|---|---|
| Sample No. | 9 | 10 | 11 |

| | | | | |
|---|---|---|---|---|
| Viscosity | ml/g | 80 | 79.5 | 69 |
| Number | | | | |
| Tensile Modulus | MPa | 11100 | 10930 | 11360 |
| Break Strength | MPa | 174 | 173 | 180 |
| Break strain | % | 2.4 | 2.3 | 2.1 |
| Charpy | kJ/m² | 82 | 79 | 79 |
| Unnotched | | | | |
| Charpy Notched | kJ/m² | 9 | 9.2 | 9.7 |

### Method

Start temperature: −10° C.
First heating to 280° C. at 10° C./min
First cooling to −10° C. at 10° C./min
Second heating to 280° C. at 10° C./min
Holding time of 5 min at each temperature

TABLE NO. 7

| | | | |
|---|---|---|---|
| Sample No. | 9 | 10 | 11 |

| | | | | |
|---|---|---|---|---|
| Crystallization | ° C. | 215 | 215 | 221 |
| onset | | | | |
| temperature | | | | |
| Crystallization | ° C. | 211 | 212 | 215 |
| temperature | | | | |
| Melting | ° C. | 248 | 248 | 249 |
| temperature | | | | |
| (second heating) | | | | |

Method [Two Measurements for Each Grade were Done]
Start temperature: 25° C.
Heating to 280° C. at 40° C./min, holding for 5 min
Cooling down to the isothermal crystallization temperature of 230° C. at 20° C./min, holding for 10 min
Cooling down to room temperature at 20° C./min

TABLE NO. 8

| Sample No. | | 9 | 10 | 11 |
|---|---|---|---|---|
| t₁ | min | 14.29/14.27 | 14.28/14.28 | 14.31/14.31 |
| t₂ | min | 15.25/15.25 | 17/17 | 14.7/14.8 |
| t₃ | min | 17.61/17.94 | 20.52/20.77 | 16.38/16.53 |
| t₂ − t₁ | min | 0.96/0.96 | 2.72/2.72 | 0.39/0.49 |
| t₃ − t₂ | min | 2.41/2.69 | 3.52/3.77 | 1.68/1.73 |
| t₂ − t₁ (avg.) | min | 0.96 | 3.64 | 0.44 |
| t₃ − t₂ (avg.) | min | 2.55 | 2.72 | 1.70 |

Total time to reach isothermal crystallization temperature: t1
Total time to the point where crystallization starts/crystallization onset: t2
Total time to the point where crystallization peak maximum is observed: t3
Induction time (time elapsed at 230° C. before crystallization starts): t2 − t1
Time at 230° C. from crystallization onset to crystallization peak maximum at 230° C.: t3 − t2

As shown above, Sample Nos. 9, 10 and 11 displayed excellent mechanical properties, particularly impact resistance properties. The formulations also displayed very fast crystallization rates.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed:

1. A polymer composition comprising:
a thermoplastic polymer;
reinforcing fibers present in the polymer composition in an amount from about 5% to about 55% by weight; and
a mold release agent, the mold release agent comprising a food contact grade component that meets the requirements of FDA CFR 21 Part 177 of the Code of Federal Regulations and/or meets European Food Contact Regulation 10/2011,
at least one nucleant, wherein the at least one nucleant comprises talc, an ionomer, a bicarbonate, a benzoate, silica, a phosphate ester, or mixtures thereof; and
wherein the polymer composition is free of sodium montanate.

2. A polymer composition as defined in claim 1, wherein the polymer composition displays a difference between time to an offset of crystallization and a time to reach an isothermal crystallization temperature of less than about 3 mins.

3. A polymer composition as defined in claim 1, wherein the nucleant comprises sodium bicarbonate.

4. A polymer composition as defined in claim 1, wherein the nucleant comprises sodium benzoate.

5. A polymer composition as defined in claim 1, wherein the nucleant comprises talc.

6. A polymer composition as defined in claim 1, wherein the mold release agent comprises a polyethylene wax.

7. A polymer composition as defined in claim 6, wherein the mold release agent comprises an oxidized polyethylene wax.

8. A polymer composition as defined in claim 6, wherein the polyethylene wax has a density greater than 0.96 g/cm³ when tested according to ISO Test 1183.

9. A polymer composition as defined in claim 6, wherein the polyethylene wax displays a drop point of from about 120° C. to about 125° C. when tested according to ISO Test 2176.

10. A polymer composition as defined in claim 6, wherein the polymer composition displays a viscosity of greater than about 1700 mPa·s when tested according to DIN Test 53019 at 140° C.

11. A polymer composition as defined in claim 1, wherein the thermoplastic polymer comprises a polyester polymer.

12. A polymer composition as defined in claim 1, wherein the thermoplastic polymer comprises a polyethylene terephthalate polymer.

13. A polymer composition as defined in claim 1, wherein the mold release agent has an acid value of from about 10 KOH/g to about 25 KOH/g.

14. A polymer composition as defined in claim 1, wherein the reinforcing fibers comprise glass fibers, the glass fibers being present in the polymer composition in an amount from about 15% by weight to about 40% by weight.

15. A polymer composition as defined in claim 1, wherein the mold release agent is present in the polymer composition in an amount less than about 2% by weight and in an amount greater than about 0.1% by weight, and wherein the at least one nucleant is present in the polymer composition in an amount less than about 2% by weight and in an amount greater than about 0.1% by weight.

16. A polymer composition as defined in claim 12, wherein the polyethylene terephthalate polymer is present in the polymer composition in an amount greater than about 50% by weight and in an amount less than about 90% by weight.

17. A polymer composition as defined in claim 1, wherein every polymer component contained in the polymer composition complies with the United States Food and Drug Administration standards listed in 21 CFR 177.

18. A polymer composition as defined in claim 1, wherein the polymer composition is free of montanic acids, salts or esters thereof.

19. A molded article made from the polymer composition as defined in claim 1.

20. A molded article as defined in claim 19, wherein the molded article comprises a component or part of a food handling equipment.

21. A molded article as defined in claim 19, wherein the molded article comprises a drip pan in an air fryer.

22. A molded article as defined in claim 19, wherein the molded article comprises a food tray.
